(19) United States
(12) Patent Application Publication
(10) Pub. No.: US 2011/0293000 A1
(43) Pub. Date: Dec. 1, 2011

(54) IMAGE PROCESSOR, IMAGE DISPLAY APPARATUS AND IMAGE PROCESSING METHOD

(75) Inventor: Himio Yamauchi, Yokohama-shi (JP)

(73) Assignee: KABUSHIKI KAISHA TOSHIBA, Tokyo (JP)

(21) Appl. No.: 13/093,591

(22) Filed: Apr. 25, 2011

(30) Foreign Application Priority Data
May 25, 2010 (JP) 2010-119907

(51) Int. Cl. H04N 7/12

(52) U.S. Cl. 375/240.12; 375/E07.243

(57) ABSTRACT

In one embodiment, an image processor includes: a decoder configured to decode a coded moving image signal, and generate a decoded moving image signal; an output module configured to output a picture type of a field or a frame of the decoded moving image signal; a detector configured to detect an inter-frame difference of the field or the frame of the decoded moving image signal at least every time the output picture type is changed; a flicker reduction module configured to reduce flicker noise included in the decoded moving image signal by using the decoded moving image signal of a plurality of the fields and frames; and a controller configured to control a strength of the reduction effect of the flicker noise with respect to the field or the frame of a same picture type as the changed picture type based on the inter-frame difference.

### CROSS-REFERENCE TO RELATED APPLICATIONS

This application is based upon and claims the benefit of priority from Japanese Patent Application No. 2010-119907, filed May 25, 2010, the entire contents of which are incorporated herein by reference.

### FIELD

Embodiments described herein relate generally to an image processor, an image display apparatus, and an image processing method.

### BACKGROUND

In transmitting and recording a moving image, a coding is performed in order to enhance transmitting efficiency and compression efficiency. On the other hand, in an apparatus which receives and reproduces a coded moving image, the coded moving image is decoded, and processing for reducing noise generated by a coding distortion is performed. Conventionally, a technique is known that a difference in pixel values between an I picture and the last P picture just prior to the I picture is reduced in order to reduce flicker noise generated by the coding distortion.

The conventional technique reduces the difference between the I picture and the P picture, but does not take into account a difference between picture types. Therefore, there is a possibility that the flicker noise cannot be reduced sufficiently.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an image processor according to an embodiment;

FIG. 2 is an exemplary schematic view of Group Of Pictures (GOP) of a decoded moving image signal in the embodiment;

FIG. 3 is an exemplary flowchart of moving image signal processing in the embodiment; and

FIG. 4 is an exemplary block diagram of a television broadcast receiver including the image processor in the embodiment.

### DETAILED DESCRIPTION

In general, according to one embodiment, an image processor comprises: a decoder, a picture type output module, an inter-frame difference detector, a flicker reduction module and a flicker reduction controller. The decoder is configured to decode a coded moving image signal coded by a predetermined moving image coding system, and generate a decoded moving image signal. The picture type output module is configured to output a picture type of a field or a frame of the decoded moving image signal. The inter-frame difference detector is configured to detect an inter-frame difference of the field or the frame of the decoded moving image signal at least every time the picture type output by the picture type output module is changed. The flicker reduction module is configured to reduce flicker noise included in the decoded moving image signal by using the decoded moving image signal of a plurality of the fields and frames. The flicker reduction controller is configured to control a strength of the reduction effect of the flicker noise by the flicker reduction module with respect to the field or the frame of a same picture type as the changed picture type based on the inter-frame difference detected by the inter-frame difference detector.

According to another embodiment, an image display apparatus comprises: a decoder, a picture type output module, an inter-frame difference detector, a flicker reduction module, a flicker reduction controller, and display. The decoder is configured to decode a coded moving image signal coded by a predetermined moving image coding system, and generate a decoded moving image signal. The picture type output module is configured to output a picture type of a field or a frame of the decoded moving image signal. The inter-frame difference detector is configured to detect an inter-frame difference of the field or the frame of the decoded moving image signal at least every time the picture type output by the picture type output module is changed. The flicker reduction module is configured to reduce flicker noise included in the decoded moving image signal by using the decoded moving image signal of a plurality of the fields and frames. The flicker reduction controller is configured to control a strength of the reduction effect of the flicker noise by the flicker reduction module with respect to the field or the frame of a same picture type as the changed picture type based on the inter-frame difference detected by the inter-frame difference detector. The display is configured to display the decoded moving image signal from which the flicker noise is reduced by the flicker reduction module.

According to still another embodiment, an image processing method comprises: decoding, by a decoder, a coded moving image signal coded by a predetermined moving image coding system, and generating a decoded moving image signal; outputting, by a picture type output module, a picture type of a field or a frame of the decoded moving image signal; detecting, by an inter-frame difference detector, an inter-frame difference of the field or the frame of the decoded moving image signal at least every time the picture type output by the picture type output module is changed; reducing, by a flicker reduction module, flicker noise included in the decoded moving image signal by using the decoded moving image signal of a plurality of the fields and frames; and controlling, by a flicker reduction controller, a strength of the reduction effect of the flicker noise by the flicker reduction module with respect to the field or the frame of a same picture type as the changed picture type based on the inter-frame difference detected by the inter-frame difference detector.

Various embodiments will be described hereinafter with reference to the accompanying drawings.

An image processor according to an embodiment will now be explained in detail with reference to the drawings.

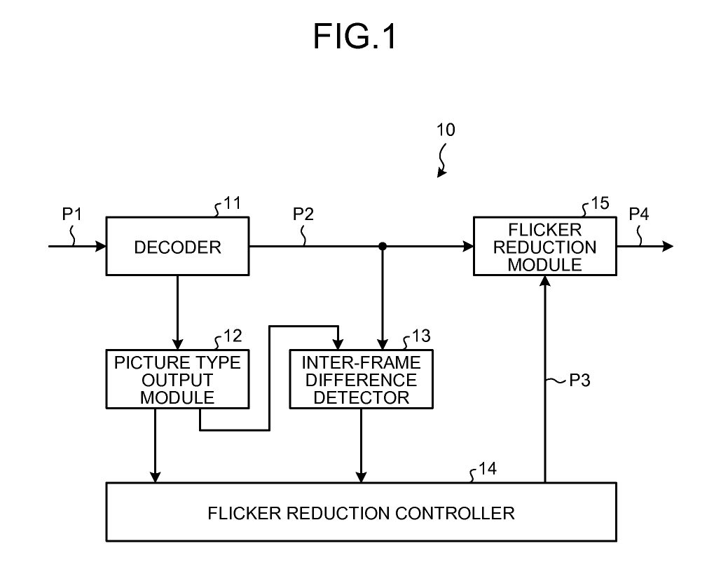

FIG. 1 is a block diagram of an image processor according to one embodiment. As illustrated in FIG. 1, an image processor 10 comprises a decoder 11, a picture type output module 12, an inter-frame difference detector 13, a flicker reduction controller 14, and a flicker reduction module 15.

Each section of the image processor 10 can be composed of a dedicated chip such as a micro controller. Alternatively, the image processor 10 can be composed of a one chip in which functions of all of the sections of the image processor 10 are integrated. Alternatively, a Central Processing Unit (CPU) can load a program stored in a Read Only Memory (ROM) and so on into a Random Access Memory (RAM) to execute the program sequentially so that each of sections of the image processor 10 is achieved.

The decoder 11 decodes a coded moving image signal P1 which is coded by a predetermined coding system to generate a decoded moving image signal P2. Here, the coding system of the coded moving image signal P1 is, for example, H.264/MPEG-4, AVC, or MPEG-2 in which a plurality of picture types such as the I picture, the B picture, the P picture are used.

The decoder 11 outputs the generated decoded moving image signal P2 to the inter-frame difference detector 13 and the flicker reduction module 15 in units of frames or fields. The decoder 11 outputs coding processing information indicating a coding condition which is adopted when the coded moving image signal P1 is coded and which is obtained when the decoder 11 decodes the coded moving image signal P1 to the picture type output module 12.

Here, the coding processing information includes information regarding the coding system such as H.264/MPEG-4, AVC, MPEG-2 and the picture type of the field or the frame. The picture type is, for example, the I picture, the P picture, and the B picture which constitute Group Of Pictures (GOP) defined in the MPEG.

The picture type output module 12 obtains, from the coding processing information input from the decoder 11, the picture type of the decoded moving image signal P2 (field or frame) output from the decoder 11 in synchronization with the output of the coding processing information. The picture type output module 12 outputs the obtained picture type to the inter-frame difference detector 13 and the flicker reduction controller 14.

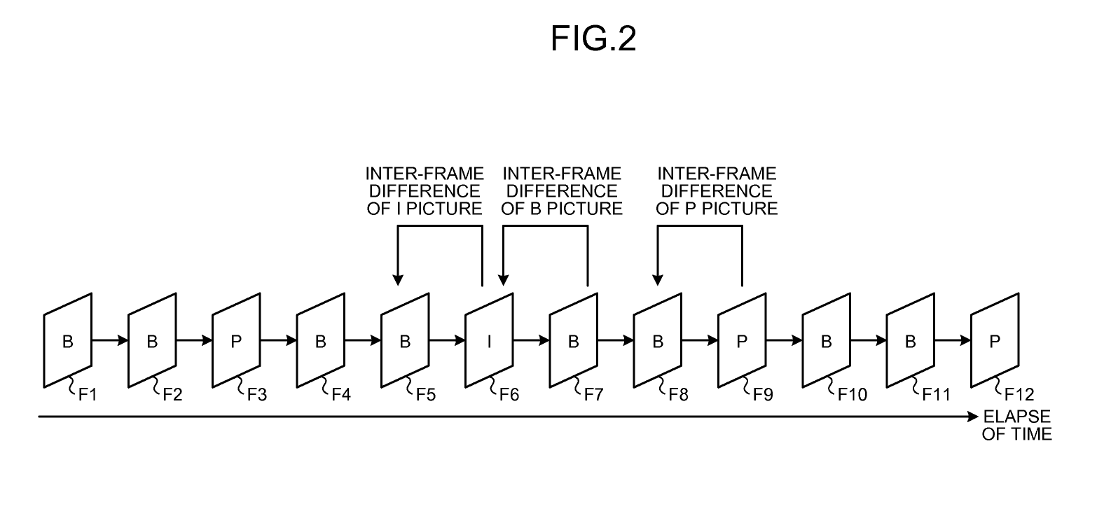

FIG. 2 is a schematic view of the GOP of the decoded moving image signal P2 in the embodiment. As illustrated in FIG. 2, the decoded moving image signal P2 comprises the I picture (the frame illustrated as “I” in FIG. 2), the P picture (the frame illustrated as “P” in FIG. 2), and the B picture (the frame illustrated as “B” in FIG. 2). In FIG. 2, the direction from the left to the right shows a time axis, and frames F1 to F12 are output from the decoder 11, sequentially in that order.

As illustrated in FIG. 2, the picture type output module 12 outputs the B pictures for the frames F1 and F2, the P picture for the frame F3, the B pictures for the frames F4 and F5, the I picture for the frame F6, the B pictures for the frames F7 and F8, the P picture for the frame F9, the B pictures for the frames F10 and F11, and the P picture for the frameF12 as the picture type of each of frames to the inter-frame difference detector 13 and the flicker reduction controller 14, sequentially.

Referring back to FIG. 1, the inter-frame difference detector 13 detects the inter-frame difference of the field or the frame of the decoded moving image signal P2 input sequentially from the decoder 11 for each of the picture types based on the picture type input from the picture type output module 12, and outputs the detected inter-frame difference to the flicker reduction controller 14.

Specifically, the inter-frame difference detector 13 comprises a buffer (not illustrated) to hold data for at least 1 frame. Every time the field or the frame of the decoded moving image signal P2 is input to the buffer from the decoder 11, a corresponding frame is held as a last frame in the buffer. When the inter-frame difference detector 13 detects a change in the picture type input from the picture type output module 12, the inter-frame difference detector 13 detects (calculates) a difference of the amounts of motion, luminance values, and so on of image of the frame of the decoded moving image signal P2 input from the decoder 11 at a timing when the inter-frame difference detector 13 detects the change and image of the last frame just prior to the frame to output as the inter-frame difference to the flicker reduction controller 14.

Next, operations of the inter-frame difference detector 13 is explained with reference to FIG. 2. When “the I picture” which is the picture type of the frameF6 is input from the picture type output module 12 after “the B picture” which is the picture type of the frames F4 and F5 is input from the picture type output module 12, the inter-frame difference detector 13 detects the change from “the B picture” to “the I picture” in the picture type. In this timing, the inter-frame difference detector 13 detects the inter-frame difference regarding the I picture after the change is done based on the frameF6 input from the decoder 11 and the frame F5 (the last frame) just prior to the frame F6 to output to the flicker reduction controller 14.

When “the B picture” which is the picture type of the frame F7 is input from the picture type output module 12, the inter-frame difference detector 13 detects the change from “the I picture” to “the B picture.” In this timing, the inter-frame difference detector 13 detects the inter-frame difference regarding the B picture after the change is done based on the frame F7 input from the decoder 11 and the frame F6 (the last frame) just prior to the frame F7 to output to the flicker reduction controller 14.

When “the P picture” which is the picture type of the frameF9 from the picture type output module 12 after “the B picture” which is the picture type of the framesF7 and F8 from the picture type output module 12, the inter-frame difference detector 13 detects the change from “the B picture” to “the P picture.” In this timing, the inter-frame difference detector 13 calculates the inter-frame difference regarding the P picture after the change is done based on the frame F9 input from the decoder 11 and the frame F8 (the last frame) input just prior to the frame F9 to output to the flicker reduction controller 14.

As just described, every time the picture type input from the decoder 11 is changed, the inter-frame difference detector 13 detects the inter-frame difference sequentially to output as the inter-frame difference after the change is done to the flicker reduction controller 14.

Referring back to FIG. 1, the flicker reduction controller 14 sets strength of reduction effect of flicker reduction processing described later performed by the flicker reduction module 15 in order to reduce flicker noise for each of the picture types based on the inter-frame difference of each of the picture types, and output the strength of reduction effect as instruction signal P3 to the flicker reduction module 15 to control operations of the flicker reduction module 15. Here, “flicker noise” means discontinuity of video which is perceived visually when frames are changed by a gap (distortion) of image content generated during the coding.

Specifically, the flicker reduction controller 14 based on the picture type input from the picture type output module 12 and the inter-frame difference input from the inter-frame difference detector 13 establishes correspondences between the picture type and the inter-frame difference. The flicker reduction controller 14 compares relative sizes of the inter-frame differences of the picture types, and if the flicker reduction controller 14 determines that the inter-frame difference of a particular picture type is larger than the inter-frame difference of other picture type, the flicker reduction controller 14 determines that there is a high possibility that flicker occurs when a change is done between the frames of the other picture type. The flicker reduction controller 14 outputs the instruction signal P3 in which the strength of the reduction effect which is given to the frame of a particular picture type determined that there is a high possibility that flicker occurs is set to be larger than the strength of the reduction effect which is given to the frame of other picture type not determined that there is a high possibility that flicker occurs to the flicker reduction module 15. As just described, the inter-frame difference detector 13 outputs the instruction signal P3 to the flicker reduction module 15 to control the strength of the reduction effect of flicker noise by the flicker reduction module 15 for the field or the frame of the same picture type as the picture type (that is to say, the picture type after the change is done) of the inter-frame difference detected by the inter-frame difference detector 13 based on the inter-frame difference.

As the inter-frame difference to be a standard during the relative sizes are compared, a various configuration can be used. For example, the inter-frame difference of any one or two predetermined picture type can be used as a reference value for a particular picture type. In this case, for example, the inter-frame difference of the B picture and/or the P picture is set as the reference value, and the inter-frame difference of the I picture can be compared with the reference value. Alternatively, the inter-frame difference of the B picture is set as the reference value, and the inter-frame difference of the P picture can be compared with the reference value. The strength of the reduction effect set in the picture type determined that flicker occurs can be varied according to a difference with respect to the reference value.

The flicker reduction module 15 performs the flicker reduction processing on each of the picture types of the field or the frame of the decoded moving image signal input from the decoder 11 in accordance with a setting of the reduction effect instructed by the instruction signal P3 to output as a flicker reduced moving image signal P4. Here, the flicker reduction processing means known frame cyclic noise reduction processing, or frame non-cyclic noise reduction processing performed by using the decoded moving image signals P2 of a plurality of the fields or the frames. That is to say, the flicker reduction module 15 varies a parameter of the strength of the reduction effect of the frame cyclic noise reduction processing or the frame non-cyclic noise reduction processing for each of the picture types in accordance with the setting of the reduction effect instructed by the instruction signal P3.

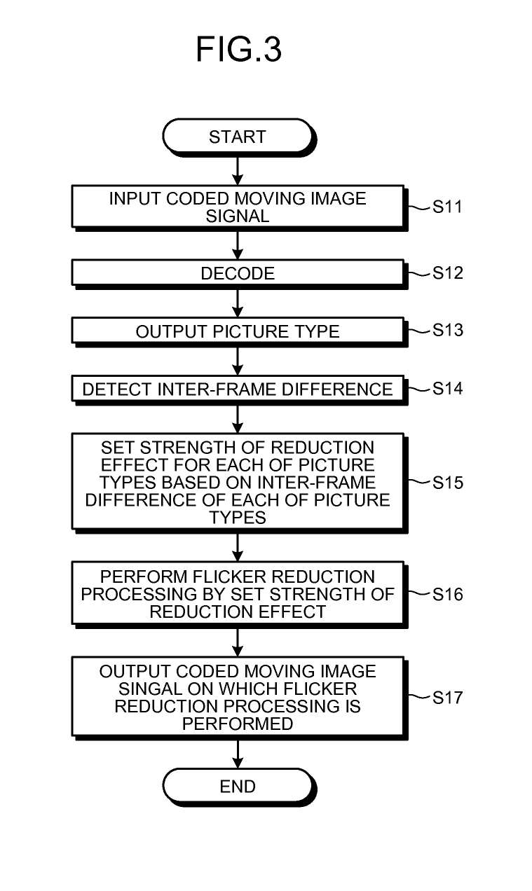

Next, operations of the image processor 10 is explained with reference to FIG. 3. Here, FIG. 3 is a flowchart of moving image signal processing performed by the sections the image processor 10 in the embodiment.

First, when the coded moving image signal P1 is input to the decoder 11 from an external apparatus (not illustrated) (S11), the decoder 11 generates the decoded moving image signal P2 in which the coded moving image signal P1 is decoded, and outputs the generated decoded moving image signal P2 in units of fields or frames to the picture type output module 12 and the flicker reduction module 15, sequentially (S12). In this timing, the decoder 11 outputs the coding processing information corresponding to the field or the frame of the output decoded moving image signal P2 to the picture type output module 12.

Next, the picture type output module 12 obtains the picture type from the coding processing information, and outputs the obtained picture type to the inter-frame difference detector 13 and the flicker reduction controller 14 (S13).

When the inter-frame difference detector 13 detects the inter-frame difference of the field or the frame input from the decoder 11 with respect to each of the changes of the picture type based on the picture type input from the picture type output module 12, the inter-frame difference detector 13 outputs the inter-frame difference to the flicker reduction controller 14 (S14).

The flicker reduction controller 14 sets the strength of the reduction effect of the flicker reduction processing for each of the picture types based on the inter-frame difference of each of the picture types to output as the instruction signal P3 to the flicker reduction module 15 (S15). Specifically, when the flicker reduction controller 14 identifies the picture type of the frame in which there is a possibility that flicker occurs based on the inter-frame difference of each of the picture types, the flicker reduction controller 14 outputs the instruction signal P3 in which the strength of the reduction effect given to the frame of the identified picture type is set to be larger than that of the reduction effect of other picture type to the flicker reduction module 15.

Next, the flicker reduction module 15 performs the flicker reduction processing on the field or the frame input from the decoded moving image signal P2 by the strength of the reduction effect of the picture type set by the flicker reduction controller 14 based on the instruction signal P3 input from the flicker reduction controller 14 (S16) to output as the flicker reduced moving image signal P4 (S17).

As just described, according to the image processor 10 of the embodiment, if the inter-frame difference of a particular picture type is larger than the inter-frame difference of other picture type, it is determined that flicker noise occurs when a change is done between the frames of the other the picture type, and the strength of the reduction effect of the flicker reduction processing which is performed on the frame of the particular picture type is controlled to be larger than that of the reduction effect of the other picture type. Therefore, it is possible to reduce occurrence of flicker noise efficiently because a difference between an image content included in the frame of the particular picture type determined that flicker noise occurs and an image content included in the frame of other particular picture types other than the particular picture type among the I picture, the B picture, and the P picture can be reduced.

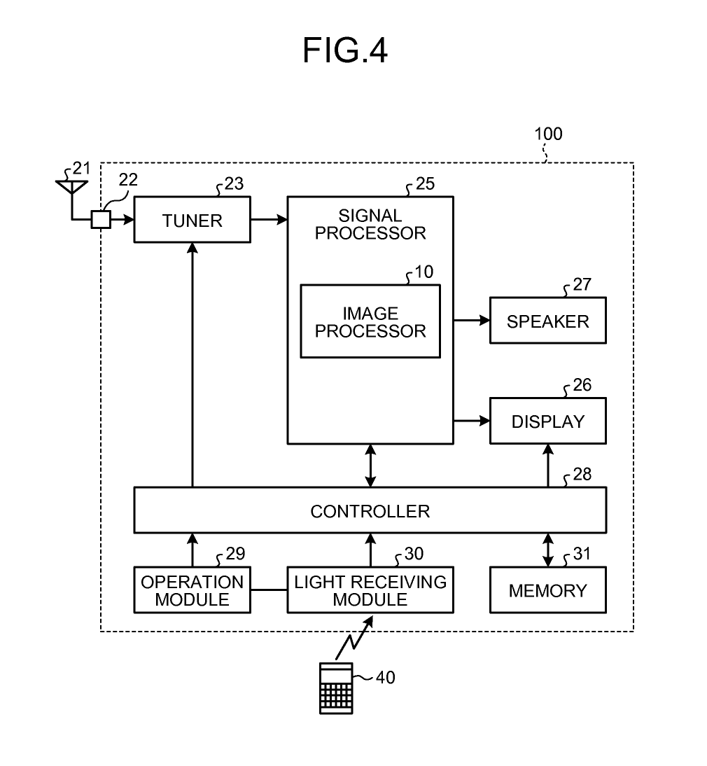

Next, an example in which the above mentioned image processor 10 is applied to a television receiver receiving and displaying a television signal is explained with reference to FIG. 4. Hereinafter, an example in which an image display apparatus is applied to the television receiver is explained, but it is not limited to. Instead of this, it can be applied to a recording and reproducing apparatus in which records data into a high capacity storage media such as a Hard Disk Drive (HDD) and a Digital Versatile Disc (DVD) and reproduces the recorded data, and a tuner, and a set top box, for example.

FIG. 4 is a block diagram of a television broadcast receiver 100 including the image processor 10 in the embodiment.

As illustrated in FIG. 4, the image processor 10 explained with reference to FIG. 1 is arranged in a signal processor 25 of the television broadcast receiver 100. In the television broadcast receiver 100, a digital television broadcast signal received at an antenna 21 for receiving a digital television broadcast is supplied to a tuner 23 through an input terminal 22. The tuner 23 performs a channel selection of the input digital television broadcast signal to decode, and outputs the decoded signal to the signal processor 25.

The signal processor 25 comprises the image processor 10 and demultiplexes video signal and audio signal and so on from the signal input from the tuner 23. Here, the decoder 11 of the image processor 10 functions as a decoder, and decodes the demultiplexed video signal as the coded moving image signal P1 to generate the decoded moving image signal P2. Each of the sections of the image processor 10 performs the above mentioned moving image signal processing to output the flicker reduced moving image signal P4 in which flicker noise included in the decoded moving image signal P2 is reduced to a display 26. Thus, the flicker reduced moving image signal is displayed on the display 26.

As the display 26, a flat panel display such as a liquid crystal display and a plasma display is used. The signal processor 25 performs a predetermined signal processing on the demultiplexed audio signal to convert digital data to analog data, and outputs to a speaker 27 to reproduce the audio signal.

Here, in the television broadcast receiver 100, a variety operations including the above mentioned receiving operations are controlled integratedly by a controller 28. The controller 28 is a microprocessor including a CPU and so on, and receives operation information such as a key operation from an operation module 29 or the operation information transmitted from a remote controller 40 through a light receiving module 30, and controls sections of the television broadcast receiver 100 such that content of the operation information is achieved. In this case, the controller 28 uses a memory 31. The memory 31 comprises a ROM in which a control program to be executed mainly by the CPU is stored, a RAM for providing a work area for the CPU, and a nonvolatile in which a variety setting information and a control information and so on is stored.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processor comprising:
a decoder configured to decode an encoded video signal and to generate a decoded video signal, wherein the encoded video signal is encoded with a first video coding system;
a picture type detector configured to output a picture type of a field or a frame of the decoded video signal;
an inter-frame difference detector configured to detect an inter-frame difference of the field or the frame of the decoded video signal at least when the picture type output by the picture type detector changes;
a flicker reduction module configured to reduce flicker noise in the decoded video signal based on a plurality of fields and frames of the decoded video signal; and
a flicker reduction controller configured to control a strength of the reduction of the flicker noise by the flicker reduction module based on the inter-frame difference detected by the inter-frame difference detector when the picture type output by the picture type detector changes.

2. The image processor of claim 1, wherein the flicker reduction controller is further configured to set the strength of the reduction with respect to the field or the frame of a first picture type to be larger than the strength of the reduction with respect to the field or the frame of a second picture type, when the inter-frame difference of a first picture type is larger than the inter-frame difference of a second picture type.

3. The image processor of claim 1, wherein the flicker reduction module is configured to reduce flicker noise using frame cyclic noise reduction processing or frame non-cyclic noise reduction processing.

4. An image display apparatus comprising:
a decoder configured to decode an encoded video signal and to generate a decoded video signal, wherein the encoded video signal is encoded with a first video coding system;
a picture type detector configured to output a picture type of a field or a frame of the decoded video signal;
an inter-frame difference detector configured to detect an inter-frame difference of the field or the frame of the decoded video signal at least when the picture type output by the picture type detector changes;
a flicker reduction module configured to reduce flicker noise in the decoded video signal based on a plurality of fields and frames of the decoded video signal;
a flicker reduction controller configured to control a strength of the reduction of the flicker noise by the flicker reduction module based on the inter-frame difference detected by the inter-frame difference detector when the picture type output by the picture type detector changes; and
a display configured to display the decoded video signal for which the flicker noise is reduced by the flicker reduction module.

5. The image processor of claim 4, further comprising a tuner configured to select a channel of a broadcast signal received by an antenna, and to output a tuned signal, wherein
the decoder is further configured to decode the tuned signal output from the tuner as the encoded video signal.

6. An image processing method comprising:
decoding, by a decoder, an encoded video signal encoded with a first video coding system;
generating a decoded video signal;
outputting, by a picture type detector, a picture type of a field or a frame of the decoded video signal;
detecting, by an inter-frame difference detector, an inter-frame difference of the field or the frame of the decoded video signal at least when the picture type output by the picture type detector changes;
reducing, by a flicker reduction module, flicker noise in the decoded video signal based on a plurality of fields and frames of the decoded video signal; and
controlling, by a flicker reduction controller, a strength of the reduction of the flicker noise by the flicker reduction module based on the inter-frame difference detected by the inter-frame difference detector when the picture type output by the picture type detector changes.
